(19) United States
(12) Patent Application Publication
(10) Pub. No.: US 2019/0197450 A1
(43) Pub. Date: Jun. 27, 2019

(54) COST ALLOCATION METHOD AND SYSTEM

(71) Applicant: Greg GUYE, Aberdeen, Aberdeenshire (GB)

(72) Inventor: Greg GUYE, Aberdeen, Aberdeenshire (GB)

(21) Appl. No.: 16/328,149

(22) PCT Filed: Aug. 24, 2017
(86) PCT No.: PCT/ZA2017/050046

§ 371 Date: Feb. 25, 2019

(30) Foreign Application Priority Data
Aug. 25, 2016 (ZA) 2016/05911

(51) Int. Cl. G06Q 10/06; G06F 17/12

(52) U.S. Cl. CPC G06Q 10/06315; G06F 17/12

(57) ABSTRACT

Method and system for allocating costs within an enterprise which has cost centres and associated measured objects (MO's). The method involves the following steps: (1) setting a first MO as a base MO and quantifying its volume based on a cost driver; (2) identifying further MO's which contribute to the base MO's functioning; (3) assigning a value of one to the direct-cost of the base MO; (4) assigning a value of zero to the direct-costs of each of said further MO's; (5) defining simultaneous linear equations as follows: a first linear equation being defined so as to equate the base MO volume to the direct-cost of the base MO, set to one, plus the volumes of said further MO's; and an additional linear equation for each of said further MO's, each of these additional linear equations being defined so as to equate the volume of each respective MO to its zeroed direct-cost plus the volumes of the further MO's contributing to its functioning; and (6) solving said equations thereby to generate iterative rates for the MO's.

### TECHNICAL FIELD

THIS INVENTION relates to a system and method for allocation of costs within organizations and enterprises. The invention has particular application in the area of internal services allocations in respect of Information Technology (“IT”). However it is not limited to that application. The technology involves the analysis of cost allocations through a cost driver methodology with the aim of understanding the true origin of the costs allocated to internal consumers and departments. Companies may have complex internal value chains, internal economies, whereby internal departments allocate or charge and consume each other's services causing recursive relationships. Understanding the cost lineage through these recursive relationships within a company is therefore an object of the invention.

### BACKGROUND ART

Enterprise Resource Planning (ERP) software is used to manage the needs of major enterprise resource areas, such as money, productive capital, people, stock and IT. However, management and control for internal service department costs, especially within non-manufacturing enterprises, lags behind the other ERP areas because of a lack of precise cost transparency.

It has been estimated that the global spend on IT in 2014 was $3.8 Trillion. Yet by some estimates around 10% to 20% of an average IT project budget is wasted. Many businesses have only a limited knowledge of what their IT budget is being spent on. Cost allocation tends to be very general. Internal service function costs may be dispersed between departments on a pro rata or arbitrary basis—such as according to floor space or by headcount—with no mechanism or incentive to control costs.

Large enterprises often distinguish between revenue and non-revenue generating departments. Non-revenue generating departments are often referred to as cost centres. Organizations which have more sophisticated internal cost discipline practices allocate cost centre costs based on cost drivers. Cost drivers can be aligned to a taxonomy of Activities, Applications, Services, Products and Processes (inter alia) referred to as measured objects (MO's). Cost centre direct costs and their consumption of other internal functions are associated with the MO's they deliver or produce. The association of direct costs and internal consumption to an MO provides a Total Cost of Ownership (TCO) measurement. Also associated with an MO is a unique cost driver, the TCO divided by the sum of the volume of the cost drivers, which provides a rate for a unit of an MO.

The TCO is an important measure as it allows the MO owners to effectively understand the bill of materials in the production of an MO. The rate of an MO is also an important measure as it allows the MO owner to establish the relative efficiency of delivery. Increasing rates imply less efficiency whilst decreasing rates imply improved efficiency.

Departments which are charged through the allocation process require information on the cost (quantity of MOs consumed×rate) of the multiple cost drivers' methodologies that may be applied by each cost centre.

The Financial division of an enterprise, on the other hand, needs to quantify the enterprise's spend for each department and for each MO, for example the spend on email accounts in a particular department. Overall, an understanding has to be reached on what the cost is of each department and what its individual contribution to revenue is.

Each department within a typical large enterprise uses different volumes (units) of MO's and consumes MO's in different quantities. For financial reporting and budgeting purposes it would be advantageous to know precisely how changes made to the direct costs of a particular department will be apportioned out amongst the various MO's and how that would impact consuming departments. If the direct cost of providing email boxes increases by an amount x, what proportion of that amount x is consumed by Department 1 and in respect of which MO's? This information should preferably be made available in so called “real-time” (near instantaneously).

A large enterprise typically has multiple departments relying upon multiple MO's. The functioning of each MO is typically dependent upon many of the other MO's. Conversely, each MO contributes towards the other MO's in complex ways. For example, each server technician requires an email account but that email account requires a server in order to function. The server requires support from a server technician, who is supported by a human resources (HR) department. The HR department relies upon a licensed software application and HR personnel who each have an email account. It will be seen that there are “recursive” feedback loops in operation. The recursive relationships make it difficult to arrive at an accurate determination of the final destinations (allocations) of the direct costs which are put into the system.

To the inventor's knowledge it has not hitherto been feasible to understand the lineage of costs through the internal value chain and to analyze cost modeling in “real time”. Conventionally, allocations have been made using so-called “single solve” linear techniques for calculating rate per MO. However, such techniques provide only a limited understanding. A single solve linear model is limiting as cost lineage through internal department charging becomes blended with other internal department allocations and an understanding of where costs are directly incurred and where those cost are finally allocated is lost.

Given the above state of the art, it will be appreciated that effective solutions and methods for accurately understanding the cost lineage of internal services would be highly advantageous. Such systems should be able to promote cost transparency by comprehensively integrating different data sources. They should be able to calculate rates for all permutations of direct cost input, and to measure any changes in respect thereof. Preferably this should be achievable in “real time”.

### Definitions

As used herein, the following terms and acronyms have the following meanings:

“App” means a software application. The term may be combined with other acronyms. For example, the terms “AppSAP” and “AppHR” used herein refer to a SAP application and a Human Resources application respectively.
“IDE” means Integrated Development Environment.
“IT” means Information Technology, also referred to as Information and Communications Technology (ICT).
“Measured Object” means a unit of spend which can be itemized and measured in respect of an application, project, process, service, function, product, activity and/or measured cost within an organisation. For example, in the IT context it may refer to a unit comprising one email account, or to a server, application, shared service support person, etc.
“MO” is an acronym for a Measured Object as defined above.
“TCO” means Total Cost of Ownership, for example the total cost of an IT product, process or service.

Internal departments of an enterprise which are non-revenue-generating are referred to herein as cost centres. Cost centre costs may be said to be “associated” with one or more MO's. Furthermore, MO costs may be said to be “allocated” to (or charged to or consumed by) revenue-generating, or non-revenue-generating, departments.

“Comprises” (or “comprising”) specifies the presence of stated features, integers, steps or components but does not preclude the presence or addition of one or more other features, integers, steps or components or groups thereof.

Symbolic References in the Claims

The claims appended to this description are to be considered as an integral part of the present disclosure. Reference letters (directed to the accompanying Tables) shown in the claims serve to facilitate the correlation of integers of the claims with illustrated features of the preferred embodiment(s), but are not intended to restrict in any way the language of the claims to what is shown in the Tables, unless the contrary is clearly apparent from the context.

### DISCLOSURE OF INVENTION

According to a first aspect of the invention there is provided a method of allocating costs within an enterprise, said enterprise comprising at least one cost centre and a plurality of measured objects (MO's), at least one of said MO's being associated with each said cost centre, and at least some of said MO's being dependent for their functioning upon one another;
said method comprising the following steps:

setting a first MO as a base MO and quantifying its total volume (“base MO volume”) based on a specified cost driver;

identifying further MO's within the enterprise which contribute to the functioning of said base MO and, for each said further MO, quantifying the volume (“volume of further MO”) in which each is required for said functioning of the base MO;

assigning a value of 1 (one) to the direct-cost of the base MO, thereby defining a unitary MO direct-cost;

assigning a value of 0 (zero) to the direct-costs of each of said further MO's;

defining a set of simultaneous linear equations comprising:
(i) a first linear equation defined so as to equate said base MO volume to said unitary MO direct-cost set to 1 plus the volumes of said further MO's;
(ii) an additional linear equation for each of said further MO's, each such equation being defined so as to equate the total volume of each respective MO to its zeroed direct-cost, plus the volumes of the further MO's which contribute to its functioning; and

solving said set of equations thereby to generate a set of values (“iterative rates”) corresponding to the base MO and further MO's.

The method typically further includes:

processing said iterative rates in order to generate cost allocations; and

allocating said cost allocations to at least one department within said enterprise, in respect of said MO.

The method may further include carrying out subsidiary steps of multiplying the iterative rates by the direct cost of a cost centre, thereby to generate a rate or cost per base unit MO.

The method may further include multiplying said rate per unit MO (and/or said iterative rate) by the volume of a particular MO, thereby to generate said cost allocations.

The method may further include a subsidiary step of generating a sum of at least one permutation of the iterative rates for a given MO and/or for a plurality of MO's.

The method of the invention is typically repeated mutatis mutandis for a plurality of MO's, such that in each case a different MO serves as the base MO. Thus, the method typically includes setting each of said plurality of MO's as the base MO and repeating the steps of the method in respect thereof.

The method therefore typically includes:

setting additional MO's as base MO's;

quantifying their total volumes based on a specified driver in each case;

identifying other MO's which contribute to the functioning of the newly set base MO in each case; and

quantifying the volume in which each of said other MO's is required for said functioning of the base MO in each case.

According to a further aspect of the invention there is provided a system for allocating costs within an enterprise, comprising:

a database loaded with data corresponding to variables and values stated for the method of the invention;

simultaneous solving means for solving the equations stated for the method of the invention, thereby to generate cost allocations; and

presentation means for presenting to a user said data, variables, values and cost allocations.

The invention thus provides a system for allocating costs within an enterprise, said enterprise comprising at least one cost centre and a plurality of measured objects (MO's), at least one of said MO's being associated with each said cost centre, and at least some of said MO's being dependent for their functioning upon one another; said system comprising:
a) a database loaded with data corresponding to:
   a quantified total volume for a predetermined base MO (“base MO volume”) based on a specified cost driver;
   in respect of each of a plurality of further predetermined MO's which contribute to the functioning of said base MO, a quantified total volume required for said functioning of the base MO (“volume of further MO”);
   a unitary MO direct-cost for the base MO with an assigned value of 1 (one);
   in respect of each of said further MO's, a direct-cost with an assigned value of 0 (zero);
   iterative rates corresponding to the base MO and further MO's, said iterative rates being solutions to a set of linear equations comprising:
      a first linear equation defined so as to equate said base MO volume to said unitary MO direct-cost set to 1 plus the volumes of said further MO's; and
      an additional linear equation for each of said further MO's, each such additional equation being defined so as to equate the total volume of each respective MO to its zeroed direct-cost plus the volumes of the further MO's which contribute to its functioning;
b) simultaneous solving means for solving said set of simultaneous linear equations; and
c) presentation means for presenting said data to a user.

The database typically also includes data corresponding to a cost per base unit MO (“rate”) comprising products of multiplication of said iterative rates by the direct cost of a cost centre.

The database typically also includes data corresponding to cost allocations in respect of at least one department within said enterprise, said allocations comprising products of multiplication of said iterative rate per unit MO by the volume of a particular MO.

The database typically also includes data corresponding to a sum of at least one permutation of the iterative rates for each of said plurality of MO's.

The method and system of the invention may be applied for the purpose of apportioning costs from cost centres to either cost centres or revenue generating departments. Conversely it may also be used to determine where direct input costs of a given cost centre and its MO's are going to. The system may allow MO's to be quantified as monetized values.

### DETAILED DESCRIPTION OF EMBODIMENTS

For a better understanding of the present invention and to show how the same may be carried into effect, specific embodiments of the invention will now be described by way of non-limiting example with reference to the accompanying Tables, which represent the output of an underlying cost modelling tool and spreadsheets developed by the inventor.

TABLE 1 shows organisational details of a scenario based on a simplified business enterprise presented for illustrative purposes.

TABLE 2 shows an example of a report and input interface generated by a cost modelling tool according to the invention. The interface is part of an underlying workbook of spreadsheets. Different values for direct costs can be entered into the interface, in each case generating a different model. The cost modelling tool can then process or “churn” the direct costs according to the method of the invention. The tool is thereby enabled to allocate costs for each proposed model on a “real time” basis. A summary of the allocations can then reported as in Table 2 or a more granular view can be presented as in other spreadsheets herein (see Tables 5 to 7).

TABLE 3 shows figures for a matrix calculation according to the method of the invention. The calculation has been performed in respect of the above-mentioned scenario for a simplified business enterprise. Amongst other results, the matrix calculation tabulates a set of iterative rates and final rates which have been calculated according to the method of the invention.

TABLE 4 shows figures for a matrix calculation according to the method of the invention. In the case of this table it is a calculation for a hypothetical, proposed model wherein certain direct costs (account line costs) have been changed relatively to those of the original scenario. This results in the generation of revised rates for the model. The iterative rates remain the same as for the scenario, however.

TABLE 5 shows a spreadsheet of the resultant model rates.

TABLE 6 shows a proof for the simplified scenario based on iterative rates.

TABLE 7 shows a proof for the scenario based on scenario rates.

Referring to Table 1, the above-mentioned hypothetical enterprise has the following MO's:
50 people (each of whom has an email account);
5 servers;
1 SAP Application (AppSAP);
1 Human Resources Application (AppHR); and
8 Shared Service Support People (SSPs) in support functions.

These MO's interact with and drive one another in complex ways. As illustrated in Table 1, the Support Service Consumption of the enterprise is as follows:
Email: 2 Servers are used by email; 1 SSP supports the email MO.
Servers: 2 SSP support the Servers.
AppSAP uses 2 Servers; 4 SSP support AppSAP (Developers).
AppHR uses 1 Server; 1 SSP supports AppHR (Developers).
8 SSPs are provided. They use AppHR and each SSP has an email box.

The system of the invention can be used to answer questions such as the following: what would the cost of ownership be for the use of servers by each of the two departments identified as Business Unit A and Business Unit B, given that those servers are supported by personnel (SSPs), each of whom has an email box and uses the AppHR, whilst each of those SSP email boxes relies not only on licences but also on servers and SSPs?

In Table 2 the reference mark Mᵢₙ indicates where values of direct costs for different models can be entered and/or changed to see their impact on allocations.

Referring now to Table 3, the block indicated by reference letter A shows an example of how the invention is implemented by performing an iterative solve for one of the five cost centres. This matrix calculation relates to the starting scenario of the enterprise as set out in Table 1. The block A relates to the “Email” cost centre of the original enterprise scenario. This has 50 email units (MO's). The implementation of the invention is carried out in part by:

assigning a value of 1 (one) to the direct-cost of the base MO (Email), thereby defining a unitary MO direct-cost; and

assigning a value of 0 (zero) to the direct-costs of the further (or contributory) MO's.

In this case the further or contributory MO's are Server, AppSAP, AppHR & SSP.

Simultaneous linear equations (IDE formulae) are then generated as shown in the block indicated by reference letter B in the table. The equations are then solved using any suitable off-the-shelf solver. The solutions appear as “iterative rates” in block C. It will be noted that the iterative rates remain unchanged across Tables 3 and 4 (i.e. across the Matrix Calculations for the starting scenario and the model respectively).

The iterative rates are then multiplied by their corresponding direct costs for each cost centre (e.g. 0.020747×ZAR 10,000 in the case of email on the first line). This results in Rates for the starting scenario (Table 3) and for the adjusted model (Table 4).

If the individual Rates are summed, the resulting totals will match the Rates generated by a single solve process. For example, if the Rates marked by the reference letters i to v in Table 3 are summed, the resulting total (Tₑₘₐᵢₗ) matches Tₑₘₐᵢₗ for the single solve.

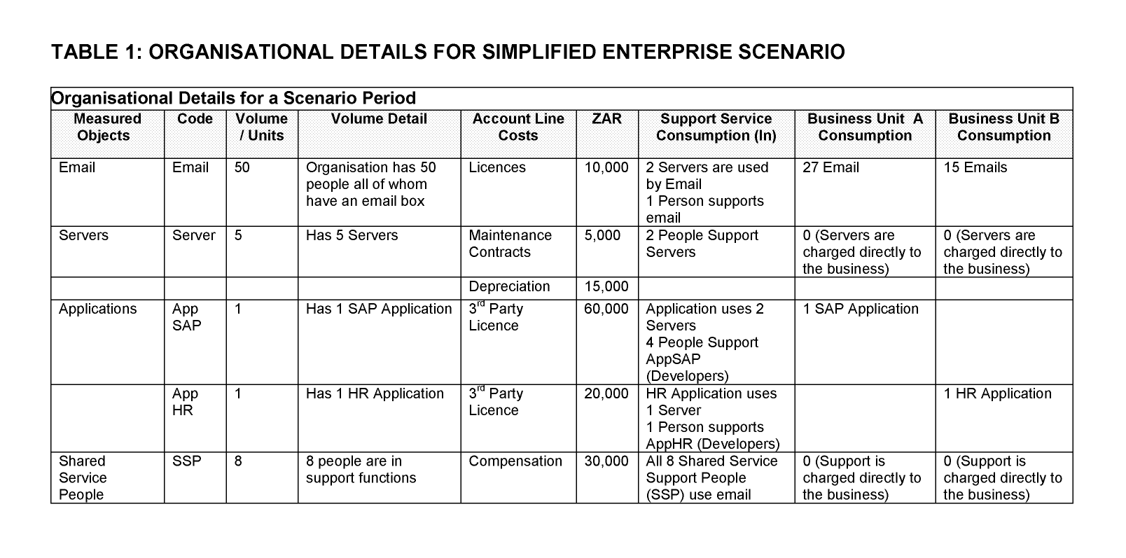

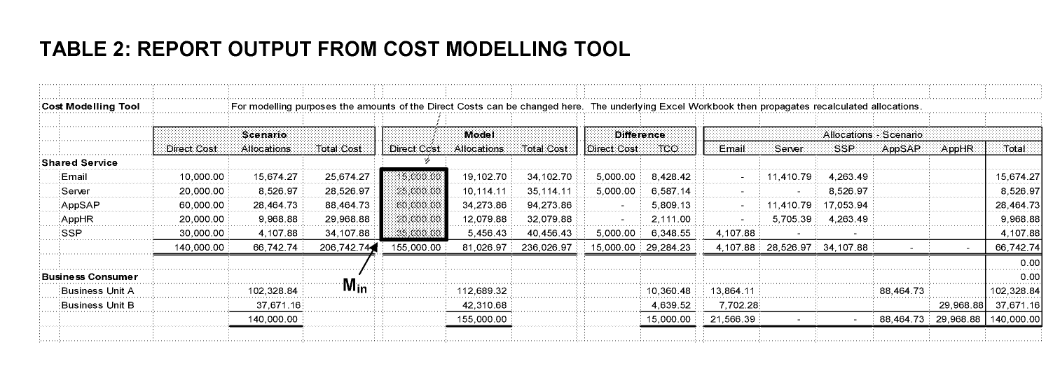

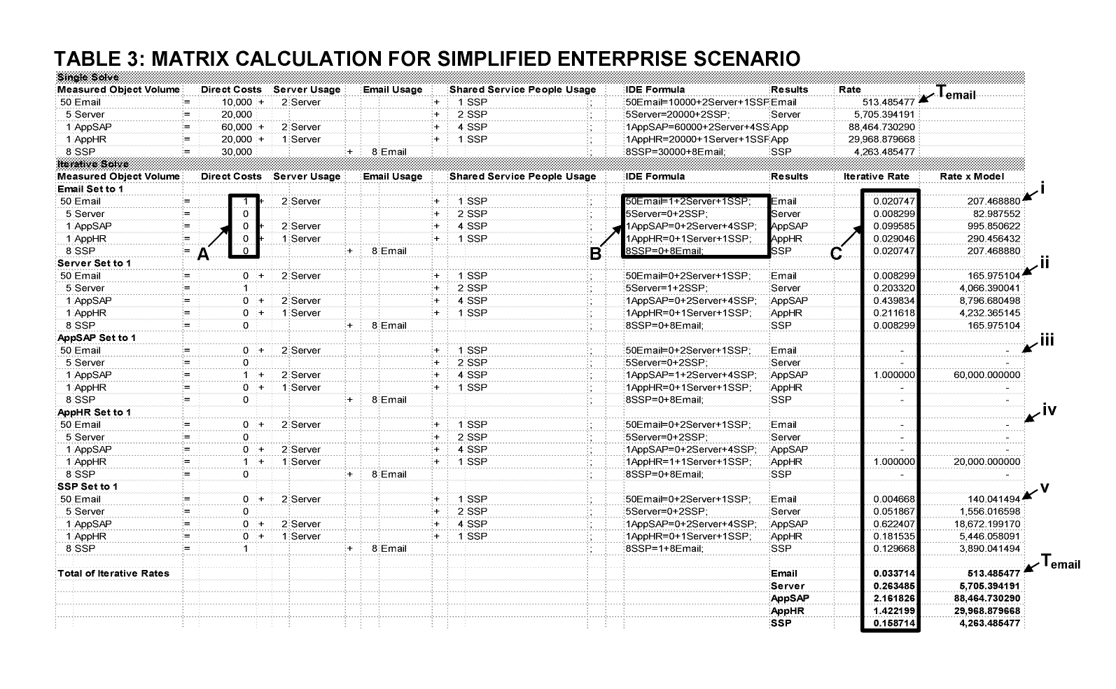

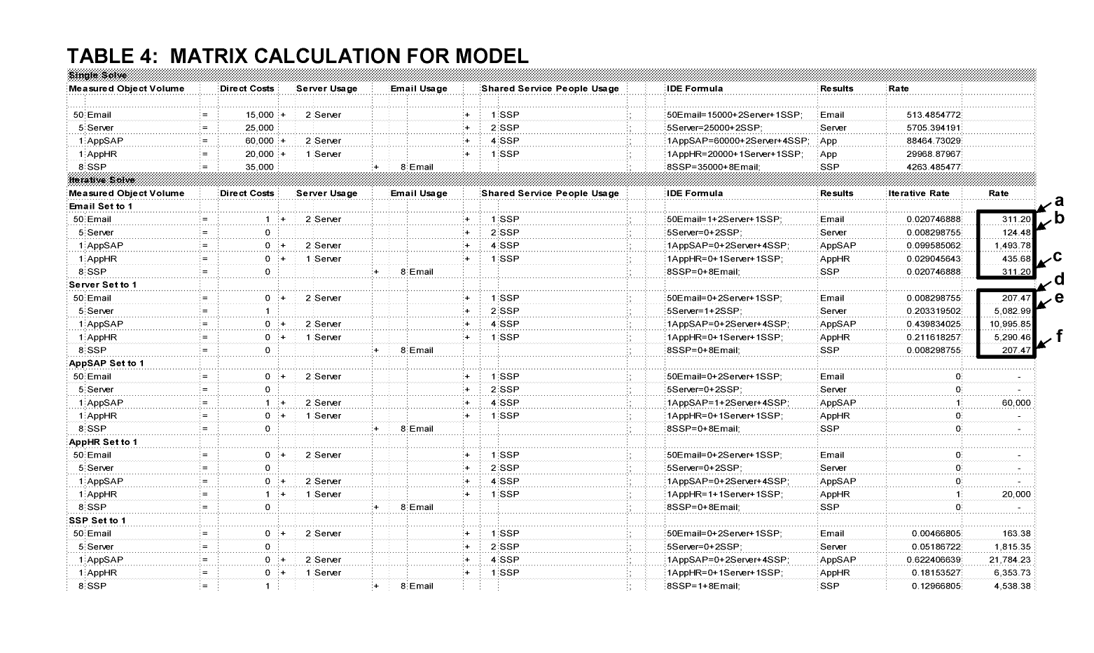

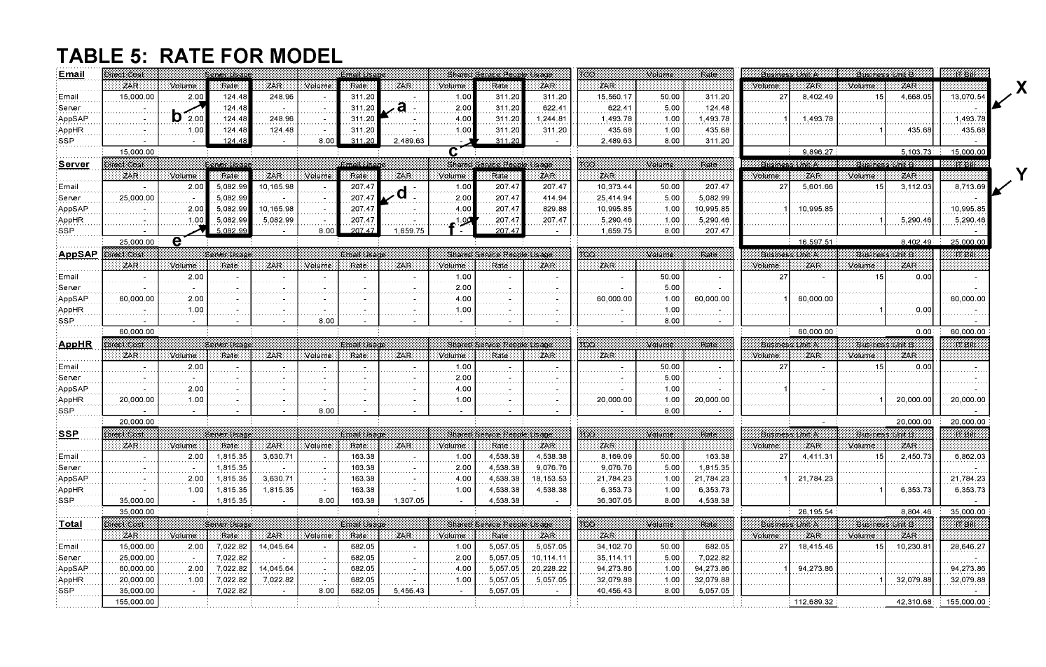

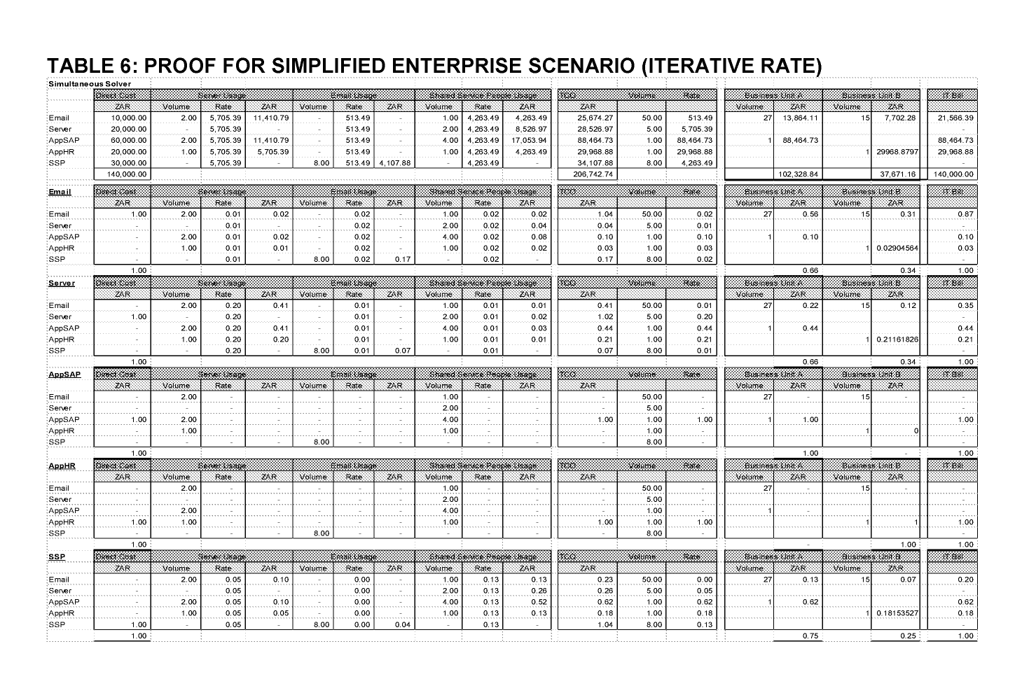

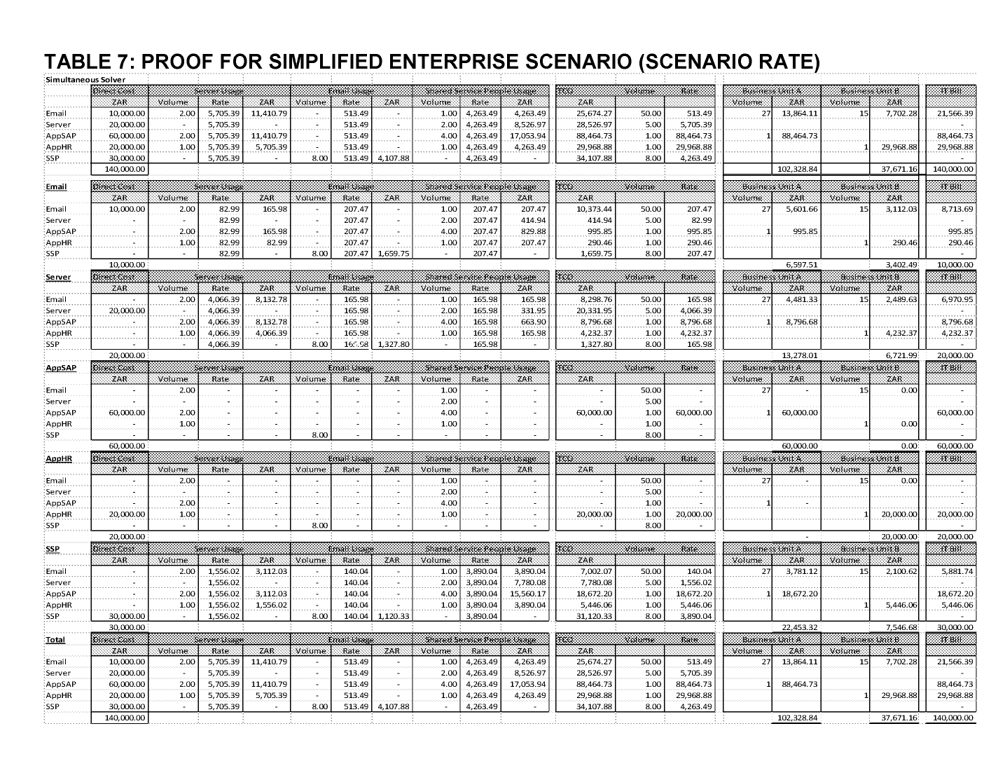

Comparing Table 4 (the matrix calculation for the model) with Table 5, it will be seen how the Rates propagate to Table 5 and are used for allocation calculations. The Rates a, b, c relate to the Email cost centre. The Rates d, e, f relate to the Server cost centre. FIG. 5 shows the destinations of the calculated Rates (a-f) in the overall Rate Sheet for the model.

The individual Rates are then used to generate the final allocations to the business units. This can be seen, for example, in the blocks indicated by the reference letters X, Y in Table 5. These results are obtained through a simple “price×quantity” type of calculation, wherein the price is the relevant Rate and the quantity is the volume for each MO.

Tables 6 and 7 show proofs of the method and system of the invention when using the Iterative Rates and the Scenario Rates respectively.

It will be appreciated that the scenario presented in the example is a simplification for illustrative purposes only. In “real world” environments the situation is far more complex. Large enterprises typically have more cost centres, business units and other departments than those used for the illustration. They also typically have higher numbers and volumes of MO's than those used for the illustration. A global corporation may, for example, have 30 000 programmers, application developers and information technology employees, 7 000 software applications, 30 data centres, 68 000 servers, 300 000 personal computers and a global network. Furthermore, multiple changes to direct costs may have to be made for multiple MO's at the same time. The system and method of the invention can be scaled up to meet the demands of such complexities.

Those skilled in the art will appreciate that variations of the invention are possible without departing from the scope thereof.

### Advantageous Effects of Invention

The allocation methodology described herein allows its users to understand cost lineage through recursive internal value chains and make “real time” observations as to the manner in which direct cost inputs affect the entire financial reporting structure of an enterprise and its departments. This has various knock-on effects and advantages. For example, the method and system can (1) facilitate real time budgeting and benchmarking; (2) show the full path of direct costs in an organization, together with their eventual destinations (line items); and (3) facilitate the assessment of TCO in respect of each MO.

The method and system display a high degree of granularity as compared with other cost allocation systems.

In the context of the departments within an organization, the method and system may be used to identify costs and to understand the consumption of MO's. Top consumers can be identified. The realism of cost estimates and budgets for future internal services projects can be better assessed. The cost implications within departments of cost decisions by other departments can be better understood.

In the context of the Finance function, the method and system may permit an organization to understand and predict its spend. It may also give insight into the scalability of costs.

Within individual departments, the method and system may assist managers to make informed strategic and tactical decisions regarding their assets and investments.

The method and system may, furthermore, contribute to the legitimacy and credibility of organizations. They may assist with compliance objectives by measuring financial numbers relating to technology spend, and may promote accountability because the various consumers who control the drivers bear their costs directly.

For reporting, tax and budgetary purposes it is advantageous for enterprises to be able to assess the cost-to-company for each node of their business and to charge accurately for internal consumption. For example, a department within an organization may wish to assess the viability of outsourcing one of the services upon which it depends. Taking an example relating to email, if the full cost of a department's participation in an internal shared email system (direct plus allocated costs) is precisely knowable at all times, then for as long as that cost remains below the cost of outsourcing the email function there is no need for that department to outsource. In a further example relating to tax regulatory affairs, the enterprise may wish to know which of its costs relates to its domestic travel and which to foreign travel so that it can transfer legitimate costs, transfer pricing, between legal entities in foreign countries. Taking a hypothetical scenario in which a member of the enterprise's Server team travels to a foreign country from Country A to carry out server maintenance, spending ZAR 100,000 on the trip, a reliable allocation system would be able to inform the enterprise that, for example, ZAR 50,000 was eventually attributable to Department 1 whilst ZAR 50,000 was attributable to Department 2. If Department 2 is located in the foreign country then ZAR 50,000 could be claimed by Country A through the transfer pricing mechanism.

In general, there is a need for enhanced visibility and understanding of costs and volumes so that enterprises can make informed strategical and tactical decisions. The present system is expected to address this need by enhancing cost transparency and by permitting decision making which is data-driven, fact-based and “real time”.

To the inventor's knowledge no model or system capable of operating recursively to provide consistent and detailed data of the above nature has been available to date.

1. A method of allocating costs within an enterprise, said enterprise comprising at least one cost centre and a plurality of measured objects (MO's), at least one of said MO's being associated with each said cost centre, and at least some of said MO's being dependent for their functioning upon one another;
wherein said method comprises the following steps:
(i) setting a first MO as a base MO and quantifying its total volume (“base MO volume”) based on a specified cost driver;
(ii) identifying further MO's within the enterprise which contribute to the functioning of said base MO and, for each said further MO, quantifying the volume (“volume of further MO”) in which each is required for said functioning of the base MO;
(iii) assigning a value of 1 (one) to the direct-cost of the base MO, thereby defining a unitary MO direct-cost [e.g. Table 3; Block A];
(iv) assigning a value of 0 (zero) to the direct-costs of each of said further MO's [e.g. Table 3; Block A];
(v) defining a set of simultaneous linear equations comprising:
a first linear equation defined so as to equate said base MO volume to said unitary MO direct-cost set to 1 plus the volumes of said further MO's [e.g. Table 3; Block B); and
an additional linear equation for each of said further MO's, each such equation being defined so as to equate the total volume of each respective MO to its zeroed direct-cost plus the volumes of the further MO's which contribute to its functioning [e.g. Table 3; Block B); and
(vi) solving said set of equations thereby to generate a set of values (“iterative rates”) corresponding to the base MO and further MO's [e.g. Table 3; Block C].

2. A method of allocating costs, as claimed in claim 1, which further includes:
processing said iterative rates in order to generate cost allocations; and
allocating said cost allocations to at least one department within said enterprise, in respect of said MO.

3. A method of allocating costs, as claimed in claim 2, which further includes multiplying the iterative rates by the direct cost of a cost centre, thereby to generate a cost per base unit MO.

4. A method of allocating costs, as claimed in claim 3, which further includes multiplying said iterative rate per unit MO by the volume of a particular MO, thereby to generate said cost allocations.

5. A method of allocating costs, as claimed in claim 4, which further includes generating a sum of at least one permutation of the iterative rates for a given MO and/or for a plurality of MO's.

6. A method of allocating costs, as claimed in claim 1, which includes setting each of a plurality of MO's as the base MO.

7. A system for allocating costs within an enterprise, said enterprise comprising at least one cost centre and a plurality of measured objects (MO's), at least one of said MO's being associated with each said cost centre, and at least some of said MO's being dependent for their functioning upon one another; said system comprising:
a) a database loaded with data corresponding to:
a quantified total volume for a predetermined base MO (“base MO volume”) based on a specified cost driver;
in respect of each of a plurality of further predetermined MO's which contribute to the functioning of said base MO, a quantified total volume required for said functioning of the base MO (“volume of further MO”);
a unitary MO direct-cost for the base MO with an assigned value of 1 (one);
in respect of each of said further MO's, a direct-cost with an assigned value of 0 (zero);
iterative rates corresponding to the base MO and further MO's, said iterative rates being solutions to a set of linear equations comprising:
a first linear equation defined so as to equate said base MO volume to said unitary MO direct-cost set to 1 plus the volumes of said further MO's; and
an additional linear equation for each of said further MO's, each such additional equation being defined so as to equate the total volume of each respective MO to its zeroed direct-cost plus the volumes of the further MO's which contribute to its functioning;
b) simultaneous solving means for solving said set of simultaneous linear equations; and
c) presentation means for presenting said data to a user.

8. A system as claimed in claim 7, wherein said database further includes data corresponding to a cost per base unit MO (“rate”) comprising products of multiplication of said iterative rates by the direct cost of a cost centre.

9. A system as claimed in claim 8, wherein said database further includes data corresponding to cost allocations in respect of at least one department within said enterprise, said allocations comprising products of multiplication of said iterative rate per unit MO by the volume of a particular MO.

10. A system as claimed in claim 9, wherein said database further includes data corresponding to a sum of at least one permutation of the iterative rates for each of said plurality of MO's.

11. A method of allocating costs, said method including any new and inventive integer or combination of integers, substantially as herein described and/or exemplified.

12. A system for allocating costs, said system including any new and inventive integer or combination of integers, substantially as herein described and/or exemplified.

13. A method of allocating costs, as claimed in claim 1, specifically as herein described with reference to or as illustrated in any one of the accompanying tables.

14. A system of allocating costs, as claimed in claim 7, specifically as herein described with reference to or as illustrated in any one of the accompanying tables.
